(19) United States
(12) Patent Application Publication
(10) Pub. No.: US 2026/0094534 A1
(43) Pub. Date: Apr. 2, 2026

(54) SYSTEM, METHOD AND APPLICATION SOFTWARE FOR TRAINING RETAIL STAFF

(71) Applicant: Hendricks Corp. Pte. Ltd., Singapore (SG)

(72) Inventors: Yilin Jia, Singapore (SG); Ricky Sanjaya, Singapore (SG); Souhail Meftah, Singapore (SG); Kin Sun Wong, Singapore (SG)

(73) Assignee: Hendricks Corp. Pte. Ltd., Singapore (SG)

(21) Appl. No.: 18/920,399

(22) Filed: Oct. 18, 2024

(30) Foreign Application Priority Data
Oct. 2, 2024 (FR) 2410614

(51) Int. Cl. G09B 9/00; G10L 15/26

(52) U.S. Cl. CPC G09B 9/00; G10L 15/26

(57) ABSTRACT

A system for training retail staff, the system comprising: an audio input device configured to receive an input audio stream spoken by a user; an audio output device configured to output an output audio stream; a display device; at least one processor; and at least one memory including computer program code; wherein the at least one processor, at least one memory and the computer program code are configured to allow the system to: receive the input audio stream spoken by the user using the audio input device; transcribe the input audio stream into transcribed text and extract relevant text results from the transcribed text using a Speech-to-Text (STT) API; generate a simulated customer response as generated text using a Generative Pre-Trained Transformer (GPT) API from the relevant text results; generate an output audio file from the generated text using a Text-to-Speech (TTS) API; play the output audio file using the audio output device as the output audio stream; evaluate performance of the user from the relevant text results and from the generated text using the GPT API according to predefined scoring guidelines for a number of evaluation categories to obtain evaluation results; and display the evaluation results on the display device.

### TECHNICAL FIELD

The present invention relates to a system, method and computer program product for training retail staff.

### BACKGROUND

Effective customer interaction is a critical component of success in the retail industry. Retail staff must be adept at engaging with customers, understanding their needs, providing accurate information about products, and resolving any issues that may arise in the process. Traditional methods of training retail staff to develop these skills have relied heavily on role-playing exercises, where a trainer (who may be an experienced employee) acts as customers to interact with the staff member being trained. However, this method has several limitations.

For example, role-playing requires significant time and effort from both trainers and trainees. It is resource-intensive and not always feasible to have experienced staff immediately available to conduct training sessions. The effectiveness of role-playing exercises can also vary greatly depending on the skills of the trainer as the trainer must be able to respond suitably in accordance with different customers personality types and temperaments. Such inconsistencies in performances can lead to uneven training experiences without a clear standard or baseline. The trainer must also have the technical knowledge of all the retail products in order to be able to properly evaluate the trainee's product knowledge. Furthermore, each trainer's observations and experience are subjective so that the trainer's evaluation of the training may not cover all aspects of the interaction comprehensively. Furthermore, the trainer must have the ability to perform a proper and detailed evaluation of the entire interaction that had taken place, keeping the evaluation metrics in mind. The trainer must also be proficient enough to decide on whether the user has passed or failed the interaction and be able provide comprehensive and sensible reasons for the judgment made. If a large number of staff need to be trained, this will require considerable logistical and timing coordination and resources to provide the training and also to accurately and comprehensively document the training results and evaluation.

Several existing solutions attempt to address various parts of the retail staff training problem, but are still lacking in their myriad ways. To address these limitations, there is a need for solution that can provide a level of comprehensive and standardised training to retail staff.

### SUMMARY

Disclosed are a system, a method and a computer program product (app) designed to harness the power of generative AI to comprehensively train retail staff. They address the limitations of traditional training methods by providing an automated, efficient, consistent, scalable, and objective approach to training. They simulate realistic staff-customer interactions, provide real-time feedback, and evaluate performance based on predefined metrics, ensuring that retail staff are well-prepared to handle diverse customer interactions in the real world.

According to a first exemplary aspect, there is provided system for training retail staff, the system comprising: an audio input device configured to receive an input audio stream spoken by a user; an audio output device configured to output an output audio stream; a display device; at least one processor; and at least one memory including computer program code; wherein the at least one processor, at least one memory and the computer program code are configured to allow the system to: receive the input audio stream spoken by the user using the audio input device; transcribe the input audio stream into transcribed text and extract relevant text results from the transcribed text using a Speech-to-Text (STT) API; generate a simulated customer response as generated text using a Generative Pre-Trained Transformer (GPT) API from the relevant text results; generate an output audio file from the generated text using a Text-to-Speech (TTS) API; play the output audio file using the audio output device as the output audio stream; evaluate performance of the user from the relevant text results and from the generated text using the GPT API according to predefined scoring guidelines for a number of evaluation categories to obtain evaluation results; and display the evaluation results on the display device.

The at least one processor, at least one memory and the computer program code may be further configured to allow the system to generate an evaluation report from the evaluation results.

The at least one processor, at least one memory and the computer program code may be further configured to allow the system to export the evaluation report as a portable document format (PDF) document and to allow the system to export an interaction text log comprising the transcribed text and the generated text as a portable document format (PDF) document.

The at least one processor, at least one memory and the computer program code may be further configured to allow the system to display an interaction text log comprising the transcribed text and the generated text on the display device.

The least one processor, at least one memory and the computer program code may be further configured to allow the system to present multiple training categories to the user and to allow the user to select a particular training category in which the user wishes to be trained.

The at least one processor, at least one memory and the computer program code may be further configured to allow the system to monitor intensity level of the input audio stream and to display the intensity level on the display device.

According to a second exemplary aspect, there is provided a method for training retail staff, the method comprising the steps of:
(a) receiving an input audio stream spoken by a user using an audio input device;
(b) transcribing the input audio stream to transcribed text and extracting relevant text results from the transcribed text using a Speech-to-Text (STT) API;
(c) generating a simulated customer response as generated text using a Generative Pre-Trained Transformer (GPT) API from the relevant text results;
(d) generating an output audio file from the generated text using a Text-to-Speech (TTS) API;
(e) playing the output audio file using an audio output device as the output audio stream;
(f) evaluating performance of the user from the relevant text results and the generated text using the GPT API according to predefined scoring guidelines for a number of evaluation categories to obtain evaluation results; and
(g) displaying the evaluation results on a display device.

The method may further comprise generating an evaluation report from the evaluation results.

The method may further comprise exporting the evaluation report as a portable document format (PDF) document.

The method may further comprise exporting an interaction text log comprising the transcribed text and the generated text as a portable document format (PDF) document.

The method may further comprise displaying an interaction text log comprising the transcribed text and the generated text on the display device

The method may further comprise, before step (a), presenting multiple training categories to the user on the display device and allowing the user to select a particular training category in which the user wishes to be trained.

The method may further comprise, after step (a), monitoring intensity level of the input audio stream and displaying the intensity level on the display device.

According to a third exemplary aspect, there is provided an application software product for training retail staff, the application software product comprising: a Speech-To-Text component comprising computer program code for transcribing an input audio stream into transcribed text and for extracting relevant text results from the transcribed text using a Speech-to-Text (STT) API, wherein the input audio stream is spoken by a user and received using an audio input device; a Text Generation component comprising computer program code for generating a simulated customer response as generated text using a Generative Pre-Trained Transformer (GPT) API from the relevant text results; a Text-To-Speech component comprising computer program code for generating an output audio file from the generated text using a Text-to-Speech (TTS) API and for playing the output audio file using an audio output device as the output audio stream; an Evaluation component comprising computer program code for evaluating performance of the user from the relevant text results and the generated text using the GPT API according to predefined scoring guidelines for a number of evaluation categories to obtain evaluation results; and a Score Card component comprising computer program code for displaying the evaluation results on a display device

The application software product may further comprise an Export Evaluation component comprising computer program code for generating an evaluation report from the evaluation results and exporting the evaluation report as a portable document format (PDF) document.

The application software product may further comprise an Export Logs component comprising computer program code for exporting an interaction text log comprising the transcribed text and the generated text as a portable document format (PDF) document.

The application software product may further comprise a Text Display component comprising computer program code for displaying an interaction text log comprising the transcribed text and the generated text on the display device.

The Speech-To-Text component may further comprise computer program code for monitoring intensity level of the input audio stream and displaying the intensity level on the display device

For all aspects, the evaluation categories may include at least one of: customer engagement, empathy, emotional intelligence, communication skills, product knowledge, problem solving, adaptability, empowerment and authority, professionalism, responding to objections, and follow-up.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

FIG. 1 is a screenshot of exemplary homepage shown on a display screen upon launching an exemplary application software configured for training retail staff.

FIG. 2 is a screenshot of an exemplary main page shown on a display screen upon selecting one of the training tools shown on the homepage of FIG. 2.

FIG. 3 is a screenshot of an exemplary “Score Card” window shown on a display screen upon completion of evaluation of a training session.

FIG. 4 is a schematic illustration of an exemplary architectural diagram of a system and an application software for training retail staff.

FIG. 5 is a flowchart of an exemplary method for training retail staff training.

### DETAILED DESCRIPTION

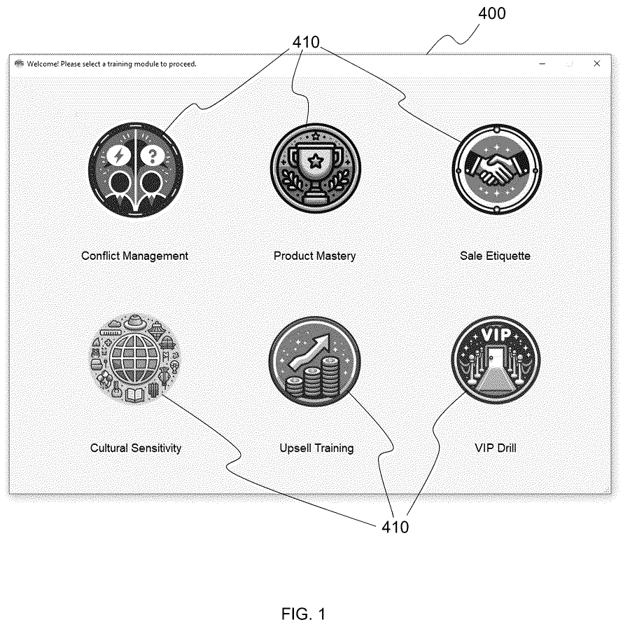

Exemplary embodiments of a system 100, method 200 and application software (app) 300 for training retail staff will be described with reference to FIGS. 1 to 5 below.

Generative AI models, such as the Generative Pre-Trained Transformer (GPT) provided by the company OpenAI™, have demonstrated the ability to generate human-like text and engage in meaningful dialogues and hold life-like conversations with human beings. Disclosed are a system 100, method 200 and app 300 that take advantage of these capabilities to create realistic simulations of customer and retail staff interactions in order to prepare retail staff for handling different customers in different scenarios. A simulated customer (preferably with a lifelike voice) is generated by the GPT for staff-customer interaction during each training session and constructive feedback is provided to the retail staff member being trained (hereinafter referred to as ‘the user’) via a highly comprehensive evaluation procedure after every training session.

In general, the system 100, method 200 and app 300 of the present invention utilize an Application Programming Interface (API) of a Generative Pre-Trained Transformer (GPT) such as that provided by OpenAI™ for example, for Natural Language Processing (NLP) tasks such as processing text and generating text responses. It also utilizes a Speech-to-Text (STT) API as that provided by OpenAI™, for example, to perform audio to text transcription. It further uses a Text-to-Speech (TTS) API such as that provided by OpenAI™, for example, to turn generated text into audible words, together referred to as audio-related tasks. As the invention 100, 200, 300 utilizes the various API for NLP and audio-related tasks, a relevant token such as an OpenAI™ token, for example, will be required to perform any requests. Aside from a stable internet connection is needed to interact with the APIs and the token for API requests, no other external dependencies are needed to push and pull requests to the APIs.

The system 100 comprise an audio input device 110 configured to receive an input audio stream spoken by a user, an audio output device 140 configured to output an output audio stream, a display device (not shown), at least one processor, and at least one memory including computer program code in the form of the installed app 300. The app 300 is built on a desktop-based framework, for example PyQT™, and thus requires desktop operating software (OS) such as Microsoft Windows™, Apple MacOS™, and GNU/Linux™. The app 300 is a standalone executable (.exe) file after compilation. In preferred exemplary embodiments, the app 300 uses exclusive technical information or proprietary information for the retail products that is not available online. Such information is not released online in order to personalize customer experience and to protect the brand image and product integrity. As such, such access to exclusive information gives the invention 100, 200, 300 technical and privilege advantages over existing solutions. For example, the app 300 features significantly improved performance and contextual understanding compared to existing solutions because of the access to more detailed specific information. Furthermore, such information enhances the training dataset and allows the GPT to have a better understanding and response generation in the context where the data is applicable. As existing training software do not have access to such information, they cannot perform as well when it comes to providing accurate and detailed information about the products.

### Usage Example

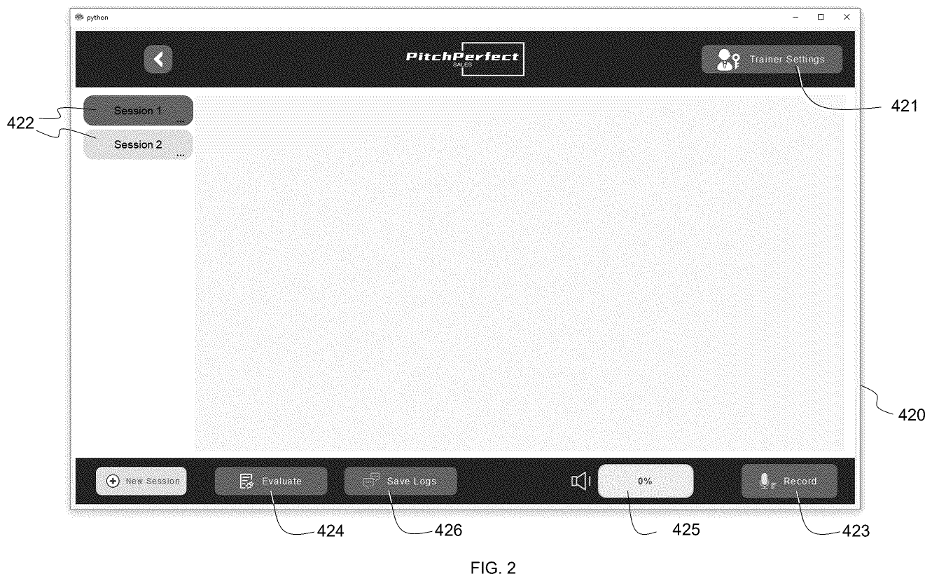

As the purpose of the invention 100, 200, 300 is to train retail staff to be better prepared with handling different customers in different scenarios, in an exemplary embodiment, the app 300 is configured to provide training for retail staff in a number of different aspects or training categories, such as conflict management, product mastery, sales etiquette, cultural sensitivity, upsell training, and very important person (VIP) drill, for example. The app 300 is configured such that when the app 300 is launched, the user is brought to a home page 400 which shows a number of graphical widget buttons 410 that each represent one of the training categories, as depicted in FIG. 1. Clicking with a mouse pointer on any one of the buttons 410 to select a training category brings the user to a main window 420 of that training category, as depicted in FIG. 2.

In the main window 420, the user can adjust the training settings by clicking on a training setting button 421, create and navigate through different sessions by clicking on session tabs 423, and control their speaking volume. In the training settings, the user can select the audio input device 110 and audio output device 140, select different voices that are used for the generated speech output, and other settings depending on the training category chosen. For the session tabs 422, the app 300 is configured to allow the user to choose to go through simulation trainings by clicking on the same tab or on another tab. The app 300 is preferably configured to allow the user to create, delete, and rename the tabs 422 as required. An audio monitoring widget 425 is preferably provided at the bottom of the main window 420 to allow the user to monitor and control his or her speaking volume to ensure that he or she is not speaking too softly or loudly. A record button 423 is provided on the main window 420 so that once the user is ready to begin the training, the user clicks on the record button 423 to start speaking. Accordingly, the system 100 is provided with an audio input device 110 (such as a microphone) to receive an input audio stream that is spoken by the user (i.e., the input audio stream comprises speech from the user).

Once the user has finished speaking, the user clicks on the record button 423 again to stop the current recording. The app 300 is configured such that doing this saves the input audio stream into an MP3 file which is sent to the STT API for audio transcription in a predetermined language, such as English, for example. The transcribed text is returned (e.g. in the JSON format) and relevant text results are extracted. The extracted text results are processed and sent to the GPT API for text response generation. The generated text from the GPT acts as the simulated customer's response to the user's input. The generated text is then sent to the TTS API to generate an MP3 output audio file. The generated output audio file comprises words that are spoken in the predetermined language and in a voice according to the selected voice setting in the training settings. The generated output audio file is then played in the app 300, for example using a Python™ library module ‘playsound’, and output as an output audio stream of audible speech by an audio output device 110 (such as a speaker or headphones) provided in the system 100. Once the output audio file has finished playing and been heard by the user, the user can click on the record button 423 to start speaking again in reply to what the simulated customer said in generated output audio response. This cycle continues until the user decides to end the simulation training.

An evaluation button 424 is provided on the main window 420 for the user to evaluate the interaction by clicking on the evaluation button 424 once the simulation training has ended. The app 300 is configured such that when the evaluation button 424 is clicked, an interaction text log documenting the entire recorded interaction (comprising the transcribed text and the generated text) is created and sent to the GPT API for evaluation. For this step, the GPT has been fitted with a prompt that contains instructions on the different aspects or evaluation categories on which to evaluate the interaction, as well as instructions on the format of the generated evaluation response.

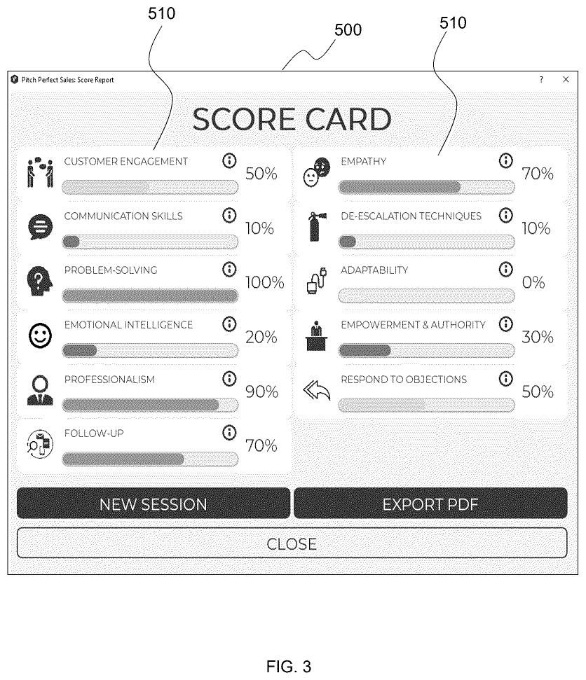

Once the evaluation has been completed, a separate ‘Score Card’ window 500 as shown in FIG. 3 may be displayed, which shows the scores for each of the evaluation categories. Preferably, the scores for each evaluation category are provided as a clickable button 510 for the user to click on each of the evaluation categories to view the evaluation details for that evaluation category. Optionally, the user may also choose to export the evaluation report as a portable document format (PDF) document which contains all the information including the evaluation scores, details, pass/fail judgement, reasons for judgement, and areas of improvement. Lastly, the user may optionally save the interaction text log (serving as an interaction history) as a PDF document by clicking on a ‘Save Logs’ button 426 provided on the main window 420.

After the evaluation has been completed, the user can choose to start a new simulation training on the current session tab or a new session tab. Optionally, once a new simulation training has begun, the evaluation and saving of interaction history may no longer be available for any of the previous interactions. This is to allow only one active session at any given time to ensure the stability of the application, and also to ensure that the user is not confused with which simulation training he or she is going through.

### Components of the App 300

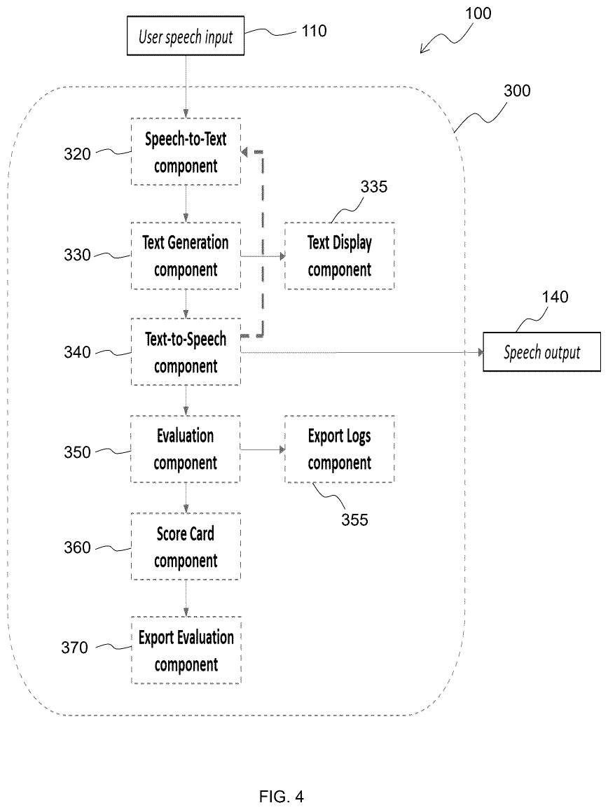

Details of each technology stack or component comprising computer program code of the app 300 will be described below with reference to FIG. 4.

The app 300 comprises a Speech-To-Text (STT) component 320 that that is configured to receive the input audio stream spoken by the user and transcribe the input audio stream into transcribed text. The STT component 320 preferably comprises two main portions: an audio capture and transcription portion, and optionally a real-time audio monitoring portion. The input audio stream may be opened and initiated using a Python™ ‘PyAudio’ library for example, that allows audio to be played and recorded on a variety of desktop OS platforms.

The audio capture and transcription portion captures the recorded input audio stream and saves it into a WAV audio file format, for example using a Python™ ‘wave’ library. The WAV file is then used directly as input data to the STT API of the GPT, which performs audio transcription to generate the transcribed text, for example in JSON format. Relevant text results from the transcribed text are extracted to be used for other components of the app 300.

The real-time audio monitoring portion performs real-time audio monitoring on the input audio stream for its intensity level (i.e. volume), for example using PyAudio. Configurations such as the number of audio channels and sample rate are first defined, and the input audio stream is then initiated. To obtain the audio intensity levels, the root mean square of the audio byte data may be calculated and compared to a pre-defined maximum audio level to determine if the user is speaking too loudly or too softly. The input audio intensity level may be displayed as a percentage (i.e., of the calculated audio value over a pre-defined maximum audio level) on an audio level meter widget 425. If the calculated value exceeds the pre-defined maximum audio level (i.e., >100%), the user is deemed to be speaking too loudly. If the calculated value is too small (i.e., <1%), the user is deemed to be speaking too softly to be detected properly. This helps the user to maintain appropriate speaking volumes by adjusting their own speaking volume based on the input audio intensity level shown on the audio monitoring widget 425, thus allowing users to correct their speaking habits on the fly. It is generally recommended that the user tries to stay within the 20-80% input audio intensity range so that the spoken words can be recorded more accurately without the risk of encountering any audio clipping (speaking too loudly) or under-modulation (speaking too softly). The audio monitoring continues until the user clicks on the record button 423 to prompt a GPT response, upon which the input audio stream will be closed.

The app 300 also comprises a Text Generation component 330 that takes in the relevant text results from the STT component 320 and sends it to the GPT in the form of a prompt. The prompt will also contain information about a selected customer personality and retail product to ensure that the response remains relevant to the ongoing conversation in the training session. Using the relevant text results, the GPT will then generate a text response (i.e. generated text) which is used for other components.

Optionally, the app 300 may include a text display component 335 that is configured to take in all of the interaction logs, i.e., all the transcribed text and all the generated text, and display them in the form of chat bubbles on the main window 420.

The app 300 further comprises a Text-To-Speech component 340 that is configured to take in the generated text output by the Text Generation component 330 and generate an output audio file based on the generated text and selected voice type. The output audio file is then played in the app 300 as described above.

Importantly, the app 300 includes an Evaluation component 350 that is configured to take in all of the interaction logs and send it to the GPT in the form of a prompt. Guidelines for scoring the user's performance in each evaluation category are also included in the evaluation prompt to guide the GPT in assessing the user's performance according to the criteria described for each evaluation category, to ensure proper and accurate evaluation of the interaction. The prompt will also contain information on the evaluation categories to be used, types of scores to be given, and the response format. The GPT will then return evaluation results as text that is used by a Score Card component 360 and an Export Evaluation component 370 as described below. The evaluation results may further include whether the user has passed or failed the simulation training, detailed reasons for the result, and areas of improvement for the categories that the user has scored poorly in. The GPT is preferably also configured to provide a conclusion that describes what the user has done well in and the necessary areas of improvement.

The Score Card component 360 is configured to take in the evaluation results from the Evaluation component 350 and display the evaluation results. The displayed evaluation results may comprise only relevant scores and evaluation details that are extracted from the evaluation results. The scores may then be displayed as percentages inside progress circles for each evaluation category on the ‘Score Card’ window described above. Preferably, the scores for each evaluation category are provided as a clickable button for the user to click on each of the evaluation categories to view the evaluation details for that evaluation category.

Optionally, the app 300 may comprise an Export Logs component 355 that is configured to take in all of the interaction logs and reformat the text to generate an interaction text log where the user identity for each interaction text log is clearly visible. This component also adds in the date and time stamps at the top of the interaction text log. This component then exports the interaction text log in the form of a PDF document, for example using a Python™ 1 fpdf2 library.

The app 300 may also optionally include an Export Evaluation component 370 that is configured to take in the evaluation results from the Evaluation component 350 and generate an evaluation report. This may comprise reformatting the evaluation results into different sections, adding appropriate headings and sub-headings, generating a radar chart based on the scores for an overall view, and providing other appropriate graphical visualization of the scores. This component then exports the reformatted evaluation results in the form of a PDF document, for example using the Python™ ‘fpdf2’ library. In this way, the full evaluation report can be exported as a PDF document for easy access and distribution where required.

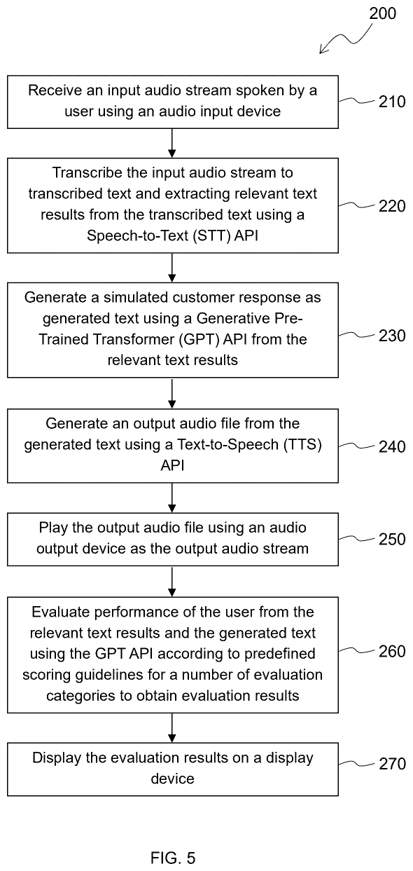

In an exemplary embodiment of the method 200 for training retail staff as depicted in the flowchart of FIG. 5, the method comprises receiving an input audio stream spoken by a user using an audio input device 210; transcribing the input audio stream to transcribed text and extracting relevant text results from the transcribed text using a Speech-to-Text (STT) API 220; generating a simulated customer response as generated text using a Generative Pre-Trained Transformer (GPT) API from the relevant text results 230; generating an output audio file from the generated text using a Text-to-Speech (TTS) API 240; playing the output audio file using an audio output device as the output audio stream 250; evaluating performance of the user from the relevant text results and the generated text using the GPT API according to predefined scoring guidelines for a number of evaluation categories to obtain evaluation results 260; and displaying the evaluation results on a display device 270.

### Exemplary Evaluation Categories

Importantly, the invention 100, 200, 300 provides comprehensive evaluation of the retail staff training via the Evaluation component 350 by evaluating various aspects of the interaction between the user with the simulated customer. The evaluation system is provided with well-defined scoring guidelines to ensure a holistic and precise assessment from the initiation to the conclusion of each simulated customer interaction in the training session. This evaluation system is designed to gauge not only the user's communication skills but also their ability to engage customers effectively, demonstrate in-depth product knowledge, maintain professionalism, resolve issues efficiently, understand their own authority in problem-solving, address customer objections adeptly, and exhibit robust follow-up skills. By thoroughly assessing these critical dimensions, use of the invention 100, 200, 300 ensures that users are exceptionally well-prepared and equipped for real-world customer interactions.

In an exemplary embodiment of the invention 100, 200, 300, eleven different aspects of the simulated customer interaction are evaluated. Each aspect may be considered an evaluation category and a score is given to each of these categories. For example, the user may be given a minimum score of 0 and a maximum score of 5 for each category that is evaluated. Details of each of the eleven exemplary categories of evaluation are given below.

(1) Customer Engagement: Measures how well the user captures and maintains the customer's interest throughout the interaction. To score well in this category, the user needs to have active listening, ask relevant questions, make the customer feel valued and understood, and provide personalized responses. By emphasizing customer engagement from the outset, users learn to build strong, positive relationships with customers, fostering loyalty and satisfaction.

(2) Empathy: Evaluates the user's ability to understand and share the feelings of the customer. To score well in this category, the user needs to demonstrate concern for the customer's issues, use empathetic language, acknowledge the customer's emotions, and offer support.

(3) Emotional Intelligence: Assesses the user's ability to recognize and manage their emotions, as well as those of the customer. To score well in this category, the user needs to maintain composure, show self-awareness, use emotional insights to guide interactions, and de-escalate tense situations. The evaluation process prioritizes empathy and emotional intelligence, ensuring that users can connect with customers on a personal level, thereby improving customer experience and retention.

(4) Communication Skills: Assesses the clarity, conciseness, and effectiveness of the user's communication. To score well in this category, the user needs to use clear and simple language, an appropriate tone and pace, avoid jargon, check for customer's understanding, and respond appropriately to customer cues. By honing clear and effective communication skills, users can convey information more accurately and persuasively, reducing misunderstandings and enhancing customer trust.

(5) Product Knowledge: Measures the user's understanding and ability to provide accurate information about the products. To score well in this category, the user needs to correctly answer product-related questions, provide detailed explanations, highlight features and benefits, and make relevant product recommendations.

(6) Problem Solving: Evaluates the user's ability to identify and resolve customer issues effectively. To score well in this category, the user needs to diagnose the problem accurately, propose viable solutions, implement solutions efficiently, and follow up to ensure the issue is resolved.

(7) Adaptability: Measures the user's ability to identify and resolve customer issues effectively. To score well in this category, the user needs to handle unexpected questions or issues, shift strategies when necessary, stay calm under pressure, and show flexibility in problem resolution. Training users to be adaptable ensures that they can manage unexpected situations gracefully, maintaining professionalism and composure under pressure.

(8) Empowerment and Authority: Evaluates the user's confidence in their role and their ability to take initiative. To score well in this category, the user needs to make decisions independently, demonstrate a sense of ownership, confidently handle customer queries, and exercise authority appropriately. Understanding and utilizing their decision-making authority empowers users to resolve issues swiftly, improving operational efficiency and customer satisfaction.

(9) Professionalism: Measures the user's adherence to professional standards and behavior. To score well in this category, the user needs to show respect and courtesy, maintain a positive demeanor, follow company policies, and uphold ethical standards. The emphasis on professionalism ensures users represent the brand impeccably, fostering a positive brand image and customer perception.

(10) Responding to Objections: Evaluates the user's ability to handle customer objections and concerns effectively. To score well in this category, the user needs to listen to objections, address concerns with valid arguments, turn objections into opportunities, and reassure the customer. Training on responding to objections helps users address customer concerns confidently, leading to higher sales conversation rates.

(11) Follow-Up: Measures the user's commitment to ensuring customer satisfaction after the initial interaction. To score well in this category, the user needs to schedule follow-up actions, provide additional support or information, check in with the customer to ensure issues are resolved, and maintain a relationship with the customer. Strong follow-up skills are crucial for building lasting customer relationships, ensuring customers feel valued and are likely to return.

From the Above Description, it Can Be Seen That the Invention 100, 200, 300 Provides the following advantages:
Comprehensive evaluation process: The evaluation framework encompasses eleven meticulously crafted categories with well-defined scoring guidelines, ensuring a holistic and precise assessment from the initiation to the conclusion of each customer interaction. This evaluation system is designed to gauge not only the user's communication skills but also their ability to engage effectively, demonstrate in-depth product knowledge, maintain professionalism, resolve issues efficiently, understand their own authority in problem-solving, address customer objections adeptly, and exhibit robust follow-up skills. By thoroughly assessing these critical dimensions, we ensure that users are exceptionally well-prepared and equipped for real-world customer interactions.
Holistic Training: The multi-faceted evaluation covers all essential aspects of the customer interaction, providing a well-rounded training experience that prepares users for diverse scenarios they might encounter in the field.
Targeted Skill Development: Each evaluation category focuses on a specific skill set, allowing users to identify and work on particular areas of improvement, leading to continuous personal and professional growth.
Conflict Resolution: The inclusion of de-escalation techniques and problem-solving evaluation category equips trained users with the tools to handle conflicts smoothly, turning potentially negative experiences into positive outcomes.
Consistent Performance: The structured evaluation provides a consistent benchmark for performance, ensuring all users meet the high standards expected by the company.
Feedback and Improvement: The detailed scoring system offers constructive feedback, allowing users to track their progress and continuously improve their skills.
User-friendliness and customer-centric solution: The invention 100, 200, 300 is extremely user-friendly as it is very easy to navigate around the landing page and main window. Furthermore, the solution offers onboarding tutorials and help guides should the user require further assistance in navigation and utilizing the features more effectively.

The presently disclosed invention 100, 200, 300 allows users to undergo diverse retail staff training at any time on an easy-to-use interface in one simple package. thus addresses the limitations of traditional training methods by offering a versatile, scalable, and effective training tool for retail staff. It integrates multiple training aspects, a user-friendly interface, and comprehensive evaluation process into a single end-to-end solution that is implemented on a user-friendly desktop application that does not require any additional software installation or external dependencies aside from an internet connection. This makes it easy to deploy and use across different systems without the need for extensive setup. The invention 100, 200, 300 also

While there has been described in the foregoing description exemplary embodiments of the present invention, it will be understood by those skilled in the technology concerned that many variations in details of design, construction and/or operation may be made without departing from the present invention. It will be appreciated that many further alterations, modifications and permutations of various aspects of the described embodiments are possible that fall within the spirit and scope of the claims.

1. A system for training retail staff, the system comprising:
an audio input device configured to receive an input audio stream spoken by a user;
an audio output device configured to output an output audio stream;
a display device;
at least one processor; and
at least one memory including computer program code;
wherein the at least one processor, at least one memory and the computer program code are configured to allow the system to:
receive the input audio stream spoken by the user using the audio input device;
transcribe the input audio stream into transcribed text and extract relevant text results from the transcribed text using a Speech-to-Text (STT) API;
generate a simulated customer response as generated text using a Generative Pre-Trained Transformer (GPT) API from the relevant text results;
generate an output audio file from the generated text using a Text-to-Speech (TTS) API;
play the output audio file using the audio output device as the output audio stream;
evaluate performance of the user from the relevant text results and from the generated text using the GPT API according to predefined scoring guidelines for a number of evaluation categories to obtain evaluation results; and
display the evaluation results on the display device.

2. The system for training retail staff according to claim 1, wherein the at least one processor, at least one memory and the computer program code are further configured to allow the system to generate an evaluation report from the evaluation results.

3. The system for training retail staff according to claim 2, wherein the at least one processor, at least one memory and the computer program code are further configured to allow the system to export the evaluation report as a portable document format (PDF) document and to allow the system to export an interaction text log comprising the transcribed text and the generated text as a portable document format (PDF) document.

4. The system for training retail staff according to claim 1, wherein the at least one processor, at least one memory and the computer program code are further configured to allow the system to display an interaction text log comprising the transcribed text and the generated text on the display device.

5. The system for training retail staff according to claim 1, wherein the at least one processor, at least one memory and the computer program code are further configured to allow the system to present multiple training categories to the user and to allow the user to select a particular training category in which the user wishes to be trained.

6. The system for training retail staff according to claim 1, wherein the evaluation categories include at least one of: customer engagement, empathy, emotional intelligence, communication skills, product knowledge, problem solving, adaptability, empowerment and authority, professionalism, responding to objections, and follow-up.

7. The system for training retail staff according to claim 1, wherein the at least one processor, at least one memory and the computer program code are further configured to allow the system to monitor intensity level of the input audio stream and to display the intensity level on the display device.

8. A method for training retail staff, the method comprising the steps of:
(a) receiving an input audio stream spoken by a user using an audio input device;
(b) transcribing the input audio stream to transcribed text and extracting relevant text results from the transcribed text using a Speech-to-Text (STT) API;
(c) generating a simulated customer response as generated text using a Generative Pre-Trained Transformer (GPT) API from the relevant text results;
(d) generating an output audio file from the generated text using a Text-to-Speech (TTS) API;
(e) playing the output audio file using an audio output device as the output audio stream;
(f) evaluating performance of the user from the relevant text results and the generated text using the GPT API according to predefined scoring guidelines for a number of evaluation categories to obtain evaluation results; and
(g) displaying the evaluation results on a display device.

9. The method according to claim 8, further comprising generating an evaluation report from the evaluation results.

10. The method according to claim 9, further comprising exporting the evaluation report as a portable document format (PDF) document.

11. The method according to claim 8, further comprising exporting an interaction text log comprising the transcribed text and the generated text as a portable document format (PDF) document.

12. The method according to claim 8, further comprising displaying an interaction text log comprising the transcribed text and the generated text on the display device.

13. The method according to claim 8, further comprising, before step (a), presenting multiple training categories to the user on the display device and allowing the user to select a particular training category in which the user wishes to be trained.

14. The method according to claim 8, further comprising, after step (a), monitoring intensity level of the input audio stream and displaying the intensity level on the display device.

15. An application software product for training retail staff, the application software product comprising:
a Speech-To-Text component comprising computer program code for transcribing an input audio stream into transcribed text and for extracting relevant text results from the transcribed text using a Speech-to-Text (STT) API, wherein the input audio stream is spoken by a user and received using an audio input device;
a Text Generation component comprising computer program code for generating a simulated customer response as generated text using a Generative Pre-Trained Transformer (GPT) API from the relevant text results;
a Text-To-Speech component comprising computer program code for generating an output audio file from the generated text using a Text-to-Speech (TTS) API and for playing the output audio file using an audio output device as the output audio stream;
an Evaluation component comprising computer program code for evaluating performance of the user from the relevant text results and the generated text using the GPT API according to predefined scoring guidelines for a number of evaluation categories to obtain evaluation results; and
a Score Card component comprising computer program code for displaying the evaluation results on a display device.

16. The application software product of claim 15, further comprising an Export Evaluation component comprising computer program code for generating an evaluation report from the evaluation results and exporting the evaluation report as a portable document format (PDF) document.

17. The application software product of claim 15, further comprising an Export Logs component comprising computer program code for exporting an interaction text log comprising the transcribed text and the generated text as a portable document format (PDF) document.

18. The application software product of claim 15, further comprising a Text Display component comprising computer program code for displaying an interaction text log comprising the transcribed text and the generated text on the display device.

19. The application software product of claim 15, wherein the Speech-To-Text component further comprises computer program code for monitoring intensity level of the input audio stream and displaying the intensity level on the display device.

20. The application software product of claim 15, wherein the evaluation categories include at least one of: customer engagement, empathy, emotional intelligence, communication skills, product knowledge, problem solving, adaptability, empowerment and authority, professionalism, responding to objections, and follow-up.
